(19) United States
(12) Patent Application Publication
(10) Pub. No.: US 2025/0055030 A1
(43) Pub. Date: Feb. 13, 2025

(54) ELECTROLYTE COMPOSITION COMPRISING ORGANOSILICON COMPOUNDS

(71) Applicant: MOMENTIVE PERFORMANCE MATERIALS INC., Waterford, NY (US)

(72) Inventors: M. G. MURALI, KARNATAKA (IN); Kartick BINDUMADHAVAN, Bangalore (IN); Karthikeyan SIVASUBRAMANIAN, Bangalore (IN); Shreedhar BHAT, Bangalore (IN)

(21) Appl. No.: 18/283,037

(22) PCT Filed: Oct. 14, 2022
(86) PCT No.: PCT/US2022/046675

§ 371 Date: Sep. 20, 2023

(51) Int. Cl. H01M 10/0567; H01M 10/42; H01M 10/0568; H01M 10/0569

(52) U.S. Cl. CPC H01M 10/0567; H01M 10/4235; H01M 10/0568; H01M 10/0569; H01M 2300/0025

(57) ABSTRACT

An organofunctional silicone or silane compound suitable for use as an electrolyte is provided. The organofunctional silicone or silane compound may be used to provide an electrolyte composition suitable for use in an electrochemical device. The organofunctional silicone or silane compound can be used as an electrolyte additive, co-solvent, solvent used in an electrolyte formulation which may be suitable for electrochemical devices.

### TECHNICAL FIELD

The present invention relates to an organofunctional silicone or silane compound, an electrolyte comprising the organofunctional silicone or silane compound, and an electrochemical device comprising the electrolyte. More particularly, the present invention relates to an organofunctional silicone or silane compound with selected functional groups. The electrolyte composition comprising the organofunctional silicone or organosilane has an excellent ionic conductivity and may be provided in a suitable form (liquid, gel, film, etc.) for use in electrochemical devices (e.g., lithium ion batteries) of various sizes and for a wide range of applications.

### BACKGROUND

Ionically conductive materials are used in a variety of electrochemical devices including primary batteries, secondary batteries, solar capacitors, sensors, electrochemical displays, etc. A common ionically conductive material is an electrolyte employing a mixture of alkyl carbonate-based liquids containing a lithium salt. These materials form passive films around the anode and cathode, which enable the battery to function efficiently. A majority of known ionically conductive electrolytes used in lithium ion batteries may be highly reactive and inflammable, which may pose safety problems particularly if the battery is overcharged to temperatures above 125° C.

Solid electrolyte materials such as polymer electrolytes and gel electrolytes (collectively referred to herein as solid polymer electrolytes or SPEs) have been developed for use as conductive material in battery applications. Solid polymer electrolytes have excellent characteristics including thin film forming properties, flexibility, lightweight, elasticity, and transparency. These materials also do not exhibit the leakage associated with other ionic conductive materials, and may prevent decrease in battery capacity during repeated use and short-circuiting of positive and negative electrode materials. Solid polymer electrolytes may also exhibit high charging/discharging efficiency, which, along with the ability to be formed as films, allows these materials to be used in various types of batteries of different sizes and shapes.

Conventional batteries employing solid polymer electrolyte technology currently use porous poly(vinylidene) fluoride (PVdF) films swollen with organic carbonate solvents. These films, however, may pose flammability hazards and deficiencies due to limited life cycles.

Improvement in safety and performance of the lithium secondary batteries has resulted in the demand for improved materials to deliver improved characteristics for lithium secondary batteries. In particular, lithium secondary batteries have to meet applications related to high-power and high-energy systems. Performance of the battery depends on voltage stability, thermal stability, electrochemical stability, and chemical stability of the electrolyte. In general, lithium ion batteries employ liquid electrolytes with high degrees of volatility, flammability, and chemical reactivity. Here lithium salts, more commonly LiPF₆, are dissolved in an organic polar solvent such as ethylene carbonate (EC) and one or more co-solvents such as dimethyl carbonate (DMC), diethyl carbonate (DEC), or ethyl methyl carbonate (EMC). These conventionally used organic electrolytes are unstable at high operational voltage (above 4.5 V). In addition, lithium salts are generally not stable in such organic solvents at high temperature (above 60° C.). Operating lithium ion batteries with these types of electrolytes under these conditions can result in degradation of electrode materials that leads to decrease in battery performance. Moreover, currently used electrolyte solvents have a low flash point (around 35° C.), which may release heat when the battery fails during the operation. Due to these limitations, currently used organic electrolytes hinder the use to develop in lithium ion batteries for high power and energy applications. Therefore, there is a need for improved electrolyte solutions for advanced lithium ion batteries.

### SUMMARY

In one aspect, the present invention provides an organofunctional silicone or silane compound and an electrolyte composition comprising such compounds.

In one aspect, the organofunctional silicone or silane compound is a silane comprising an organic polar group. In one embodiment, the organofunctional silicone or silane compound is a silane comprising an organic polar group and a polyalkylene ether group.

In another aspect, the organofunctional silicone or silane compound is a carbosilane comprising a organic polar group. In one embodiment, the carbosilane comprises organic polar end groups. In another embodiment, the carbosilane comprises polyalkylene ether end groups.

In a further aspect, provided is an electrolyte composition comprising an organofunctional silicone or silane compound in accordance with any of the previous embodiments, and a salt. In embodiments, the salt is a lithium salt.

In still another aspect, the present invention provides an electrochemical device comprising the present electrolyte compositions.

The present organofunctional silicone or silane compounds and electrolytes comprising the same can provide improved performance in an electrochemical device including improved high current density performance and fire retardancy.

In one aspect, provided is an electrolyte comprising an organofunctional silicone or silane compound of the formula (I):

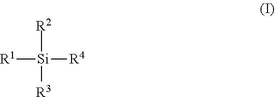

where R¹, R², and R³ are each independently selected from a C1-C10 alkyl, a C1-C10substituted alkyl, a C5-C30 cyclic alkyl, a C6-C30 aryl, a C2-C10 ether, a group of formula (ia), and a group of formula (ib); and R⁴ is selected from a group of formula (ia) or (ib);
where formula (ia) and (ib) are represented by the formulas:

Vₑ[(CH₂)_{f}]X (ia)

W_{g}[(CH₂)ₕ(Y)ᵢ(Z)ⱼ(CH₂)ₖ(CH₂O)ₗ]X (ib)

where V is a heteroatom selected from oxygen, nitrogen, and sulfur;
W is a heteroatom selected from oxygen, nitrogen, and sulfur;
Z is a heteroatom selected from oxygen, nitrogen, and sulfur;
e is 0 or greater;
f is 0 or greater, where (e+f) is greater than 1;
g, h, i, j, k, and l are each independently 0 or greater, where (g+h+i+j+k+l) is greater than 0;
Y is selected from an alkyl silyl group optionally substituted with a halogen atom; and
X is selected from (i) a C1-C10 alkyl group when 1 is greater than 0, or (ii) an organic polar group; with the proviso that when R¹, R², and R³ are each selected from a C1-C10 alkyl and R⁴ is a group (ia) then X is selected from an amide, a thioamide, an isocyanate, an isothiocyanate, a thiocyanate, a sulfone, a sulfoxide, a sulfonate, a fluoroalkyl, a sulfamide, a sulfonoamide, a carbamide, a thiocarbamide, an imide, a sulfonoimide, a nitro, an ether, an oxolane, a furan, a lactone, a thiolane, a thiophene, a pyridine, a fluoroalkyl substituted phenyl, a pyrrolidone, or a pyrrole.

In one embodiment, when not subject to the proviso, the organic polar group X is selected from a group selected from a nitrile, an amide, a thioamide, an isocyanate, an isothiocyanate, a thiocyanate, a sulfone, a sulfoxide, a sulfonate, a fluoroalkyl, a sulfamide, a sulfonoamide, a carbamide, a thiocarbamide, an imide, a sulfonoimide, a nitro, an ether, an oxolane, a furan, a lactone, a dioxolanone, a thiolane, a thiophene, a pyridine, a fluoroalkyl substituted phenyl, a pyrrolidone, a pyrrole, or a combination of two or more thereof.

In one embodiment, the organofunctional silicone or silane compound is of the

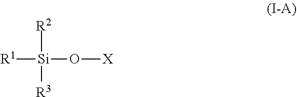

wherein R¹, R², and R³ are a C1-C10 alkyl.

In one embodiment, the R⁴ of the organofunctional silicone or silane compound of the formula I-A is a furfuryl group, provided that R¹, R², and R³ are other than a polyalkylene ether group.

In one embodiment, the organofunctional silicone or silane compound is of the formula (I-B), wherein in formula (I), R³ is a polyalkylene ether group, and R⁴ is of the formula (ia):

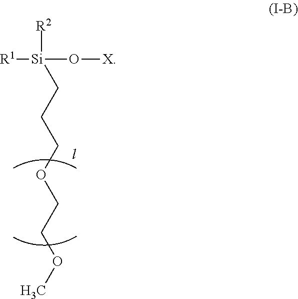

In one embodiment, X, R¹ and R² are other than a furfuryl group.

In one embodiment, the electrolyte comprises at least one group of the formula (ib), where g is 0, h is greater than 0, and i is greater than 0 so as to form a carbosilane.

In one embodiment, the organofunctional silicone or silane compound is of the formula (I-C):

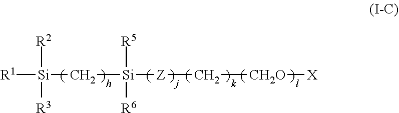

where R¹, R², and R³ are as described above; R⁵ and R⁶ are independently a C1-C10 alkyl, C1-C10 substituted alkyl, or a halogen atom; and Z, X, h, j, k, and l are as described above

In one embodiment, the organofunctional silicone or silane compound is of the formula (I-D):

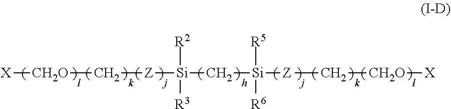

wherein the Z groups can be the same or different from one another, the X groups can be the same or different from one another, the j values can be the same or different from one another, the k values can be the same or different from one another, and the l values can be the same or different from one another, where R², and R³ are as described above; R⁵ and R⁶ are independently a C1-C10 alkyl or substituted alkyl or a halogen atom; and Z, X, h, j, k, and l are as described above.

In one embodiment, the organofunctional silicone or silane compound is of the formula (I-F):

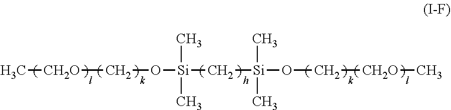

where, h, k, and l are as described above, and the k values may be the same or different from each other, and the l values may be the same or different from each other.

In one embodiment, the organofunctional silicone or silane compound is of the formula (I-G), where R², and R³ are as described above; R⁵ and R⁶ are independently a C1-C10 alkyl or substituted alkyl or a halogen atom; and X, and h, are as described above, the X groups can be the same or different from one another:

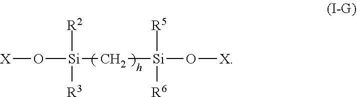

In one embodiment, the organofunctional silicone or silane compound is of the formula (I-H):

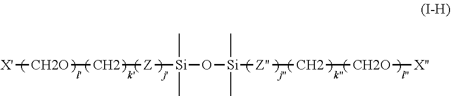

wherein the X′ and X″ groups are different from one another, the Z′ and Z″ groups can be the same or different from one another, the j′ and j″ values can be the same or different from one another, the k′ and k″ values can be the same or different from one another, and the l′ and l″ values can be the same or different from one another.

In one embodiment, the X′ and X″ is selected from (i) a C1-C10 alkyl group when l′ and l″ is greater than 0, or from the organic polar group X.

In one embodiment, the organofunctional silicone or silane compound is of the formula (I-I), where k′ and k″ values are k values as described above and can be the same or different from one another, and l″ is an l value as described above:

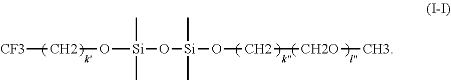

In one embodiment, the organofunctional silicone or silane compound is of the formula (I-J):

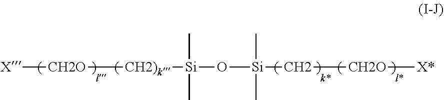

wherein the X′″ and X* groups are chosen from X as described above and are different from one another, the k′″ and k* are chosen from a k value as described above and can be the same or different from one another, and l′″ and l* have an l value as described above and can be the same or different from one another.

In one embodiment, X′″ and X* is selected from (i) a C1-C10 alkyl group when l′″ and l* is greater than 0, or from (ii) the organic polar X.

In one embodiment, the organofunctional silicone or silane compound is of the formula (I-K), where k′″ and k* are chosen from a k value as described above and can be the same or different from one another, l* has an l value as described above:

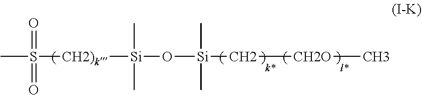

In one embodiment of the electrolyte of any previous embodiment, the organic polar group is independently selected from a group of the formula (X-i to X-xii):

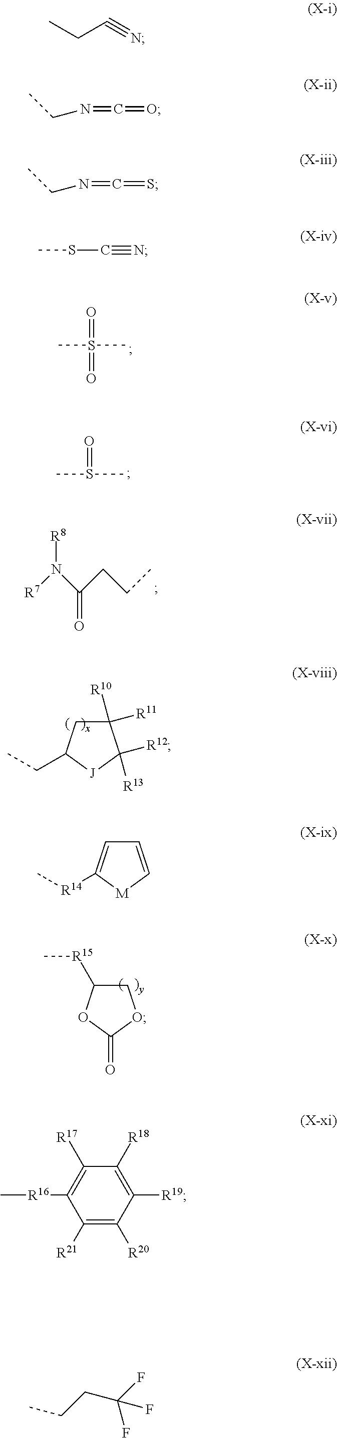

where R⁹, R¹⁴, R¹⁵, and R¹⁶ are independently selected from an organic spacer, e.g., a C1-C6 alkyl;
R⁷ and R⁹ are independently selected from H or a C1-C6 alkyl;
R¹⁰, R¹¹, R¹², and R¹³ are independently selected from H, a C1-C6 alkyl, or a halogen atom (e.g., F); x is 1-10;
y is 1-10;
J and M are independently selected from O, S, or N;
R¹⁷, R¹⁸, R¹⁹, R²⁰, and R²¹ are independently selected from H, a C1-C6 alkyl, and a C1-C6 fluoroalkyl, with the proviso that at least one of R¹⁷, R¹⁸, R¹⁹, R²⁰, and R²¹ is a fluoroalkyl.

In one embodiment of the electrolyte of any previous embodiment, the organic polar group is independently selected from a group of the formula (X-ii to X-ix, and/or X-xi):

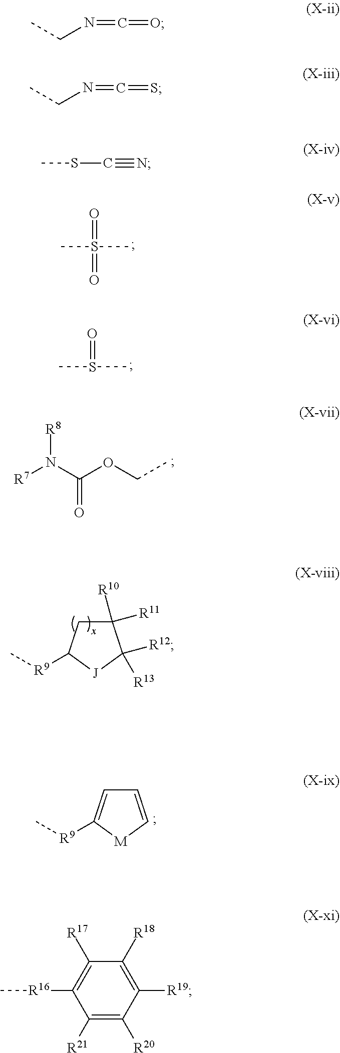

where R⁹, R¹⁴, R¹⁵, and R¹⁶ are independently selected from an organic spacer, e.g., a C1-C6 alkyl;
R⁷ and R⁹ are independently selected from H or a C1-C6 alkyl;
R¹⁰, R¹¹, R¹², and R¹³ are independently selected from H, a C1-C6 alkyl, or a halogen atom (e.g., F);
x is 1-10;
y is 1-10;
J and M are independently selected from O, S, or N;
R¹⁷, R¹⁸, R¹⁹, R²⁰, and R²¹ are independently selected from H, a C1-C6 alkyl, and a C1-C6 fluoroalkyl, with the proviso that at least one of R¹⁷, R¹⁸, R¹⁹, R²⁰, and R²¹ is a fluoroalkyl.

In one embodiment of the electrolyte of any previous embodiment, unless subject to the proviso, X is an organic polar group independently selected from:

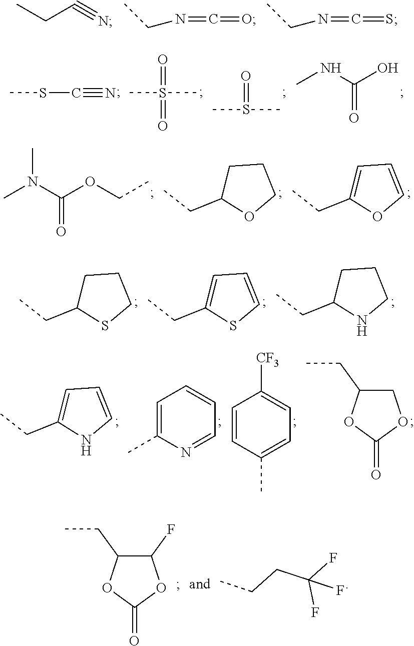

In one embodiment of the electrolyte according to any of the previous embodiments, the organofunctional silicone or silane compound is an electrolyte additive, a solvent, and/or a co-solvent.

In one embodiment of the electrolyte according to any of the previous embodiments, the organofunctional silicone or silane compound is an electrolyte additive disposed in a solvent selected from a group consisting of toluene, xylene, hexane, DMF, THF, DCM, DMSO, NMP, and ethyl acetate.

In another aspect, provided is an electrolyte composition comprising (i) an electrolyte of any of the previous embodiments; and (ii) a salt.

In one embodiment of the electrolyte composition, the salt is a lithium salt. In one embodiment of the electrolyte composition, the lithium salt is chosen from LiClO₄, LiCF₃SO₃, LiBF₄, LiPF₆, LiAsF₆, LiN(SO₂C₂F₅)₂, Li(CF₃SO₂)₂N, Li(CF₃SO₂)₃C, LiN(SO₂C₂F₅)₂, lithium alkyl fluorophosphates, organoborate salts, or a combination of two or more thereof.

In one embodiment of the electrolyte composition according to any of the previous embodiments, the electrolyte composition comprises (iii) a solvent. In one embodiment, the solvent is selected from an alkyl carbonate, a cyclic carbonate, a glyme, a polyalkylene glycol dialkyl ether, or a combination of two or more thereof.

In one embodiment of the electrolyte composition according to the previous embodiments, the composition further comprises (iv) a cosolvent. In one embodiment, the cosolvent is selected from an alkyl carbonate, a cyclic carbonate, a glyme, a polyalkylene glycol dialkyl ether, or a combination of two or more thereof.

In one embodiment of the electrolyte composition according to the previous embodiments, the electrolyte is a solid electrolyte, a liquid electrolyte, or a gel electrolyte. In one embodiment, the composition further comprises (v) a plasticizer wherein the plasticizer is chosen from an alkyl carbonate, a cyclic carbonate, a glyme, a polyalkylene glycol dialkyl ether, or a combination of two or more thereof.

In one embodiment of the electrolyte composition according to the previous embodiments, the organofunctional silicone or silane compound is present in an amount of from about 0.5 to about 5 wt. % based on the total weight of the composition.

In one embodiment of the electrolyte composition according to the previous embodiments, the organofunctional silicone or silane compound is present in an amount of from about 1 to about 3 wt. % based on the total weight of the composition.

In still another aspect, provided is an electrochemical device comprising the electrolyte composition of any of the previous embodiments.

In yet another aspect provided is an electrolyte composition comprising adding an electrolyte of any of the previous embodiments to a salt solution.

In one embodiment, the electrolyte additive is added in an amount of from about 0.5 wt. % to about 5 wt. % based on the weight of the electrolyte composition.

In one embodiment, the electrolyte composition of any previous embodiment has a flash point of from about 50° C. to about 200° C.; from about 75° C. to about 175° C.; or from about 100° C. to about 150° C.

In still yet another aspect, provided is a method of forming an electrochemical device comprising: (i) injecting the electrolyte composition of any of any previous embodiment into a spiral wound cell or a prismatic cell; or (ii) coating a surface of an electrode substrate with the electrolyte composition of any of the previous embodiments and assembling the electrode substrate with a porous separator; or (iii) providing a precursor solution comprising the electrolyte composition of any of the previous embodiments; forming a solid or gel composition from the precursor solution to form a film on an anode substrate, a cathode substrate, and/or a separator; and positioning the separator between the anode substrate and the cathode substrate such that the electrolyte contacts the anode and the cathode.

These and other aspects of the invention may be further understood with reference to the following figures and detailed description.

### BRIEF DESCRIPTION OF THE DRAWINGS

FIG. 1 is a cyclic voltammogram of a half cell employing a reference electrolyte solution;

FIG. 2 is a cyclic voltammogram of a half cell employing an electrolyte in accordance with aspects and embodiments of the present technology;

FIG. 3 is a graph showing the cyclic stability of an electrolyte in accordance with aspects and embodiments of the present technology.

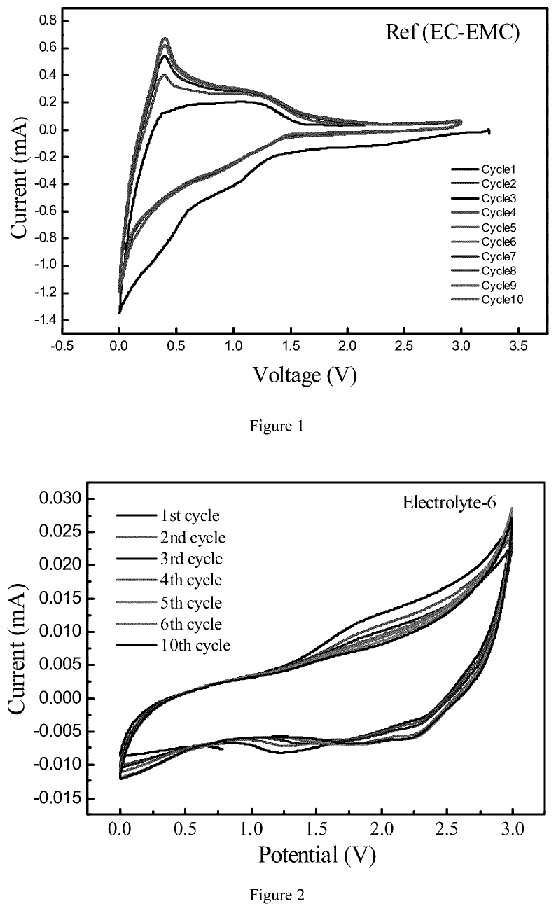

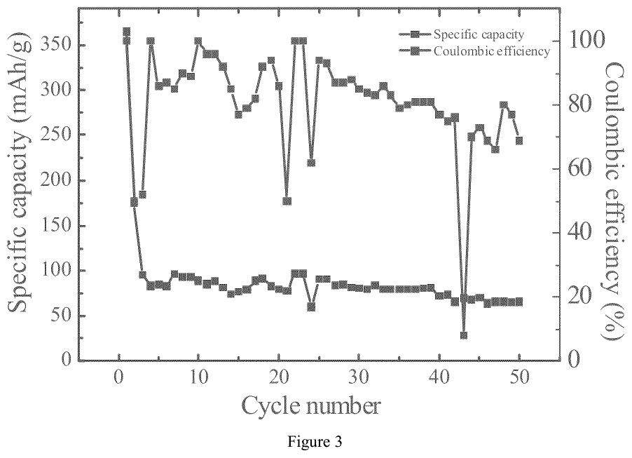

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The term “alkyl” means any monovalent, saturated straight, branched, or cyclic hydrocarbon group; the term “alkenyl” means any monovalent straight, branched, or cyclic hydrocarbon group containing one or more carbon-carbon double bonds where the site of attachment of the group can be either at a carbon-carbon double bond or elsewhere therein; and, the term “alkynyl” means any monovalent straight, branched, or cyclic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein. Examples of alkyls include, but are not limited to, methyl, ethyl, propyl, and isobutyl. Examples of alkenyls include vinyl, propenyl, allyl, methallyl, ethylidenyl norbornane, ethylidene norbornyl, ethylidenyl norbornene and ethylidene norbornenyl. Examples of alkynyls include, but are not limited to, acetylenyl, propargyl and methylacetylenyl.

The expressions “cyclic alkyl,” “cyclic alkenyl,” and “cyclic alkynyl” include bicyclic, tricyclic, and higher cyclic structures as well as the aforementioned cyclic structures further substituted with alkyl, alkenyl, and/or alkynyl groups. Representative examples include, but are not limited to, norbornyl, norbornenyl, ethylnorbornyl, ethylnorbornenyl, cyclohexyl, ethylcyclohexyl, ethylcyclohexenyl, cyclohexylcyclohexyl and cyclododecatrienyl.

The terms “alkyl” and “cyclic alkyl” include unsubstituted and substituted alkyl compounds. Unsubstituted alkyl compounds refer to those compounds having an H or other alkyl group attached to a carbon atom. Substituted alkyl compounds refer to alkyl groups where one or more hydrogen atoms are substituted with a substituent group. Examples of substituent groups for the substituted compounds include, but are not limited to, —OH, alkoxy, acetyl, thiol, thioester, sulfide, sulfone, sulfoxide, nitrile, carboxyesters, ethers, urea, thiourea, sulfone, sulfate, vinyl, acryl, aryl, arylkyl, nitro, nitroxide, amine, amide, furyl, perfuryl, thiophene, carbonate, halogen, etc. Where the number of carbon atoms is referenced for a substituted alkyl (e.g., C1-C10 substituted alkyl), it refers to the number of carbon atoms in the main portion of the alkyl chain and is not inclusive of carbon atoms that may be present in the substituent group.

The terms “fluoroalkyl” or “fluorinated alkyl” are used interchangeably herein and refer to substituted alkyl compounds in which one or more hydrogen atoms have been substituted by the same number of fluorine atoms. The term fluoroalkyl includes perfluorinated alkyl groups in which all of the hydrogen atoms on all of the carbon atoms have been substituted with fluorine atoms as well as fluorinated alkyl groups in which fewer than all of the hydrogen atoms have been substituted with fluorine atoms. Examples of fluorinated alkyl groups include, but are not limited to, —CH₂F, —CHF₂, —CF₃, —CH₂CF₃, —CF₂CF₃, etc.

The term “aryl” means any monovalent aromatic hydrocarbon group. The term “aryl” may include and encompass substituted aryl groups or groups comprising aryl substituent groups such as, but not limited to, aralkyl or arenyl. The term “aralkyl” means any alkyl group (as defined herein) in which one or more hydrogen atoms have been substituted by the same number of like and/or different aryl (as defined herein) groups; and, the term “arenyl” means any aryl group (as defined herein) in which one or more hydrogen atoms have been substituted by the same number of like and/or different alkyl groups (as defined herein). Examples of aryl groups include phenyl and naphthalenyl. Examples of aralkyl groups include benzyl and phenethyl. Examples of arenyl groups include tolyl and xylyl.

The present invention provides an organofunctional silicone or silane compound and an electrolyte composition comprising such compound(s). The present organofunctional silicone or silane compounds and the electrolyte composition comprising the organofunctional silicone or silane compounds are suitable for use in electrochemical devices. The organofunctional silicone or silane compounds may be components of an electrolyte. For example, the organofunctional silicone or silane compounds may be an electrolyte additive, may be a solvent, or a co-solvent. Examples of suitable electrochemical devices include, but are not limited to, charge-storage devices such as batteries, cells, capacitators, etc.

The organofunctional silicone or silane compound employed in the present technology is a compound of the formula (I):

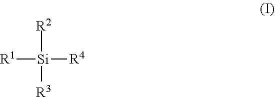

where R¹, R², and R³ are each independently selected from a C1-C10 alkyl, a C1-C10 substituted alkyl, a C5-C30 cyclic alkyl, a C6-C30 aryl, a C2-C10 ether, a group of formula (ia), and a group of formula (ib); and R⁴ is selected from a group of formula (ia) or (ib);
where formula (ia) and (ib) are represented by the formulas:

Vₑ[(CH₂)_{f}]X (ia)

W_{g}[(CH₂)ₕ(Y)ᵢ(Z)ⱼ(CH₂)ₖ(CH₂O)ₗ]X (ib)

where V is a heteroatom selected from oxygen, nitrogen, and sulfur;
W is a heteroatom selected from oxygen, nitrogen, and sulfur;
Z is a heteroatom selected from oxygen, nitrogen, and sulfur;
e is 0 or greater;
f is 0 or greater, where (e+f) is greater than 1;
g, h, i, j, k, and l are each independently 0 or greater, where (g+h+i+j+k+l) is greater than 0;
Y is selected from an alkyl silyl group optionally substituted with a halogen atom; and
X is selected from (i) a C1-C10 alkyl group when 1 is greater than 0, or (ii) an organic polar group; with the proviso that when R¹, R², and R³ are each selected from a C1-C10 alkyl and R⁴ is a group (ia) then X is selected from an amide, a thioamide, an isocyanate, an isothiocyanate, a thiocyanate, a sulfone, a sulfoxide, a sulfonate, a fluoroalkyl, a sulfamide, a sulfonoamide, a carbamide, a thiocarbamide, an imide, a sulfonoimide, a nitro, an ether, an oxolane, a furan, a lactone, a thiolane, a thiophene, a pyridine, a fluoroalkyl substituted phenyl, a pyrrolidone, or a pyrrole.

In one embodiment, (e+f) is from about 2 to about 10; from about 3 to about 8; or from about 4 to about 6.

In one embodiment, (g+h+i+j+k+l) is from about 1 to about 20; from about 4 to about 10; or from about 2 to about 6.

In one embodiment, g is from about 0 to about 2; or from about 1 to about 2. In one embodiment, h is from about 0 to about 10; from about 1 to about 8; or from about 2 to about 6. In one embodiment, i is from about 0 to about 2. In one embodiment, j is from about 0 to about 2; from about 1 to about 2. In one embodiment, k is from about 0 to about 10; from about 2 to about 8; or from about 3 to about 6. In one embodiment, 1 is from about 0 to about 10; from about 2 to about 6; or from about 3 to about 5.

In some embodiments, the alkyl silyl group Y may include a halogen atom which substitutes for a hydrogen atom bonding to a carbon atom. In some embodiments, the alkyl silyl group Y may have a cyclic structure. In embodiments, the alkyl silyl group can have an ether bond or a thio-ether bond. In one embodiment, the alkyl silyl group is represented by the formula:

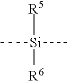

where R⁵ and R⁶ are independently selected from a C1-C10 alkyl, a C1-C10 substituted alkyl, or a halogen atom (e.g., F). In embodiments, R⁵ and R⁶ are each a C1-C10 alkyl and in certain embodiments are each methyl.

When X is an organic polar group, the organic polar group, except when subject to the proviso discussed above, can be selected from the group consisting of a nitrile, an amide, a thioamide, an isocyanate, an isothiocyanate, a thiocyanate, a sulfone, a sulfoxide, a sulfonate, a fluoroalkyl, a sulfamide, a sulfonoamide, a carbamide, a thiocarbamide, an imide, a sulfonoimide, a nitro, an ether, an oxolane, a furan, a lactone, a dioxolactone, a thiolane, a thiophene, a pyridine, a fluoroalkyl substituted phenyl, a pyrrolidone, a pyrrole, or a combination of two or more thereof.

In embodiments, the organic polar group, except when subject to the proviso, can be selected from a group of the formula (X-i to X-xii):

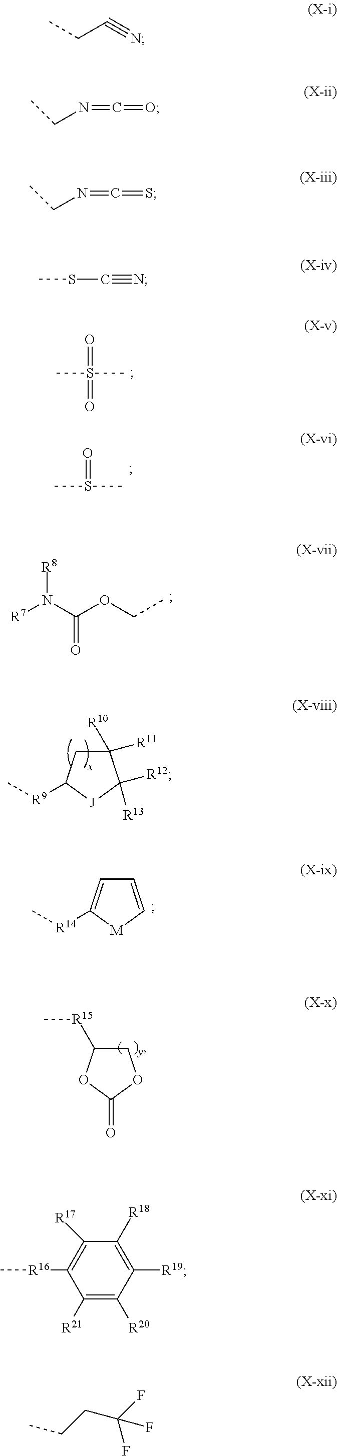

where R⁹, R¹⁴, R¹⁵, and R¹⁶ are each independently selected from a bond (i.e., is null), or an organic spacer, e.g., a C1-C10 alkyl;
R⁷ and R⁹ are each independently selected from H or a C1-C10 alkyl;
R¹⁰, R¹¹, R¹², and R¹³ are each independently selected from H, a C1-C10 alkyl, a C1-C10 substituted alkyl, or a halogen atom (e.g., F);
x is 1-10;
y is 1-10;
J and M are independently selected from O, S, or N;
R¹⁷, R¹⁸, R¹⁹, R²⁰, and R²¹ are each independently selected from H, a C1-C10 alkyl, a C1-C10 substituted alkyl, or a C1-C10 fluoroalkyl, with the proviso that at least one of R¹⁷, R¹⁸, R¹⁹, R²⁰, and R²¹ is a fluoroalkyl. In one embodiment, when subject to the proviso for X described above, X can be chosen from (X-i to X-xii).

Some non-limiting examples of organic polar groups include the following groups:

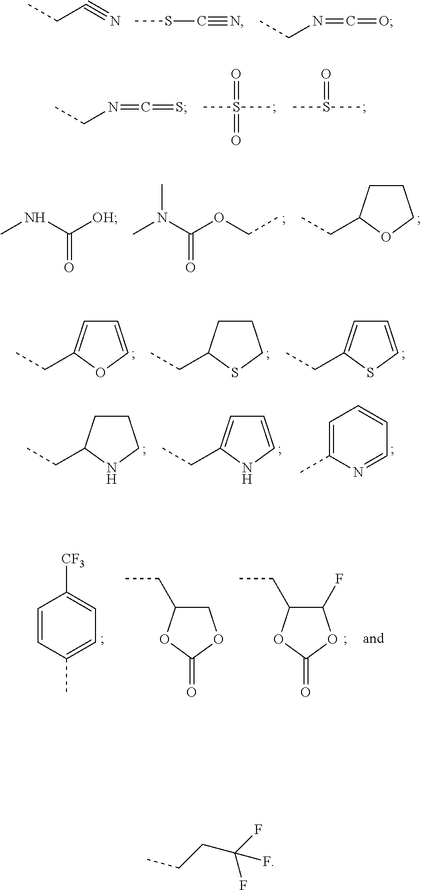

In one embodiment, the organofunctional silicone or silane compound is a compound of the formula (I) where R⁴ is of the formula (ia), and R¹, R², and R³ are C1-C10 alkyl groups. In one embodiment, R¹, R², and R³ are methyl groups. In one embodiment, in the formula (ia), f is 0 and e is 1, and wherein V is 0, therefore, R⁴ is —O—X, and the silicon compound is of the formula (I-A):

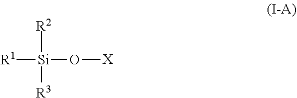

where R¹, R², and R³ can be any group as described above. In embodiments R¹, R², and R³ are a C1-C10 alkyl, and in embodiments methyl, and X is selected from one of X-ii to X-ix, or X-xi, described above. When the organofunctional silicone or silane compound is of the formula I-A and R⁴ is a furfuryl group, then R¹, R², and R³ are other than a polyalkylene ether group.

In another embodiment of the organofunctional silicone or silane compound of Formula (I), R⁴ is of the formula (ia), and R³ is of the formula (ib). In one embodiment where R³ is of the formula (ib), the group (ib) is a polyalkylene ether group of the formula —[(CH₂)ₖ(CH₂O)ₗ]X, where X is a C1-C10 alkyl (and in some embodiments, it is methyl). In one embodiment, the organofunctional silicone or silane compound is of the formula (I-B):

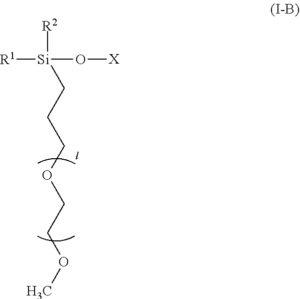

where X is a polar organic group as described above. When the organofunctional silicone or silane compound is of the formula I-B, then X, R¹, and R² are other than a furfuryl group. In one embodiment, X is a C1-C10 fluoroalkyl group, e.g., —CF₃, and R¹ and R² are a C1-C10 alkyl group (e.g., methyl).

In one embodiment, the organofunctional silicone or silane compound is a carbosilane comprising one or more Si-alkyl-Si linkages. In accordance with Formula (I), a carbosilane is present when R⁴ is of the formula (ib), g is 0, h is 1 or greater, i is 1 or greater, and Y is an alkyl silyl group. In one embodiment, the carbosilane is a compound of the formula (I-C):

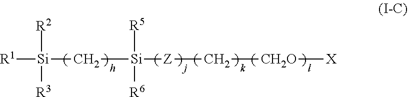

where R¹, R², and R³ are as described above; R⁵ and R⁶ are independently a C1-C10 alkyl, a C1-C10 substituted alkyl, or a halogen atom; and Z, X, h, j, k, and l are as described above.

In one embodiment, the organofunctional silicone or silane compound is a carbosilane of the formula (I-D):

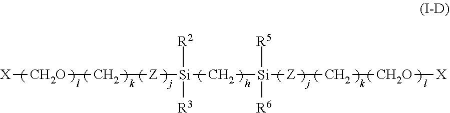

where R², R³, are as described above; R⁵ and R⁶ are independently a C1-C10 alkyl, a C1-C10 substituted alkyl, or a halogen atom; and Z, X, h, j, k, and l are as described above; the Z groups can be the same or different from one another, the X groups can be the same or different from one another, the j values can be the same or different from one another, the k values can be the same or different from one another, and the l values can be the same or different from one another.

In one embodiment, the Z groups are the same as each other, the X groups are the same as each other, the j values are the same as each other, the k values are the same as each other, and the l values are the same as each other.

In one embodiment, the organofunctional silicone or silane compound is a polyether functionalized carbosilane of the formula (I-F):

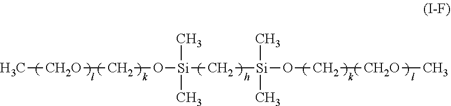

where h, k, and l can be as described above, and the k values may be the same or different from each other, and the l values may be the same or different from each other.

In one embodiment, the organofunctional silicone or silane compound is a carbosilane of the formula (I-G) comprising polar functional groups:

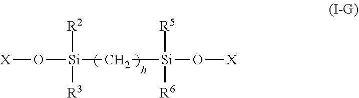

where R², R³, R⁵, R⁶, h, and X can be as described above, and X can be the same or different from one another. In one embodiment, the X groups are the same as each other.

In one embodiment, the organofunctional silicone or silane compound is a siloxane of the formula (I-H):

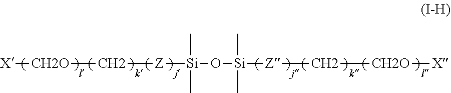

wherein the Z′ and Z″ groups are chosen from a Z group as described above and can be the same or different from one another, the X′ and X″ groups are chosen from an X group as described above and are different from one another, the j′ and j″ values are j values as described above and can be the same or different from one another, the k′ and k″ values are k values as described above and can be the same or different from one another, and the l′ and l″ values are l values as described above and can be the same or different from one another.

In one embodiment, X′ and X″ is each independently selected from (i) a C1-C10 alkyl group when l′ and l″ is greater than 0, or (ii) from an organic polar group X of formula (X-i to X-xii) as described above.

In one embodiment, the organofunctional silicone or silane compound is a polyether functionalized carbosilane comprising fluoro substituted alkyl, of the formula (I-I):

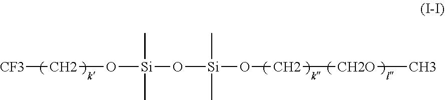

where k′ and k″ values are k values as described above and can be the same or different from one another, and l″ is an l value as described above.

In one embodiment, the organofunctional silicone or silane compound is a polyether functionalized carbosilane of the formula (I-J):

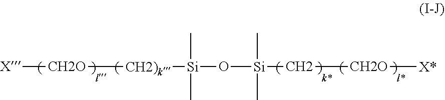

wherein the X′″ and X* groups are chosen from X as described above and are different from one another, the k′″ and k* are chosen from a k value as described above and can be the same or different from one another, and l′″ and l* have an l value as described above and can be the same or different from one another. In one embodiment, X′″ and X* are each independently selected from (i) a C1-C10 alkyl group when l′″ and l* is greater than 0, or otherwise from (ii) an organic polar group of formula (X-i to X-xii).

In one embodiment, the organofunctional silicone or silane compound is a polyether functionalized carbosilane comprising sulfone functionality, as shown in the structure of formula (I-K):

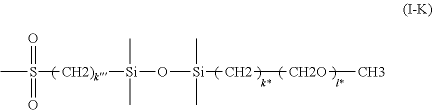

where k′″ and k* are chosen from a k value as described above and can be the same or different from one another, l* has an l value as described above.

In embodiments, the electrolyte comprises an electrolyte additive composition comprising the organofunctional silicone or silane compounds. The electrolyte may further comprise a salt, a solvent, or a co-solvent. In some embodiments, the electrolyte additive composition comprises (i) an organofunctional silicone or silane compound as described herein, and (ii) a solvent. Examples of suitable solvents include, but are not limited to toluene, xylene, hexane, DMF, THF, DCM, DMSO, NMP, Ethyl acetate, or a combination of two or more thereof. The electrolyte composition may further comprise (iii) a cosolvent. In embodiments, the cosolvent is selected from toluene, xylene, hexane, DMF, THF, DCM, DMSO, NMP, Ethyl acetate, or a combination of two or more thereof. It will be appreciated that the cosolvent is present in a minor amount relative to the other solvent(s). In some other embodiments, the organofunctional silicone or silane compounds, as described herein, may also be employed as a solvent or a co-solvent for an electrolyte.

The organofunctional silicone or silane compounds can be made by any suitable method. Silicone compounds can be made by hydrosilylation reaction using suitable metal catalyst such as Pt, Rh, Ru, or Ir. In addition, silicone compounds are functionalized using suitable solvents, which includes but is not limited to, toluene, xylene, hexane, DMF, THF, DCM, DMSO, NMP, Ethyl acetate. During the reaction, organic base is used, for non-limiting examples, pyridine, alkyl amine, imidazole, or benzimidazole. Further, inorganic base may include, but is not limited to, lithium hydroxide, sodium hydroxide, potassium hydroxide, cesium hydroxide, magnesium hydroxide, calcium hydroxide, sodium carbonate, potassium carbonate, cesium carbonate, sodium bicarbonate can be used.

In an embodiment, the present organofunctional silicone or silane compounds may be used to provide an electrolyte composition. The electrolyte composition is a liquid electrolyte. The electrolyte composition may comprise (i) at least one organofunctional silicone or silane compound, and (ii) a salt. It will be appreciated that the electrolyte may comprise a plurality of organofunctional silicone or silane compounds. Where a plurality of organofunctional silicone or silane compounds is employed, the respective organofunctional silicone or silane compounds may have the same or different structures.

In one or more embodiments, the electrolyte is made of the following procedure. The electrolyte for testing may be prepared inside an argon filled glove box with the addition of different amounts of additive in electrolyte. For example, the organofunctional silicone or silane compounds can be added in the electrolyte composition in an amount of from about 0.5 to about 5 wt. %, about 1 to about 4 wt. %, or about 2 to about 3 wt. % based on the weight of the electrolyte composition. In one embodiment, the organofunctional silicone or silane compound(s) is added in an amount of about 1 to about 3 wt. %.

The salt employed in the electrolyte is not limited to any particular salt and may be chosen for a particular purpose or application. Suitable salts include, but are not limited to, alkali metal salts. The electrolyte may comprise a plurality of different salts. In one embodiment, the salt is a lithium salt. Examples of suitable lithium salts include, but are not limited to, LiClO₄, LiCF₃SO₃, LiBF₄, LiPF₆, LiAsF₆, LiN(SO₂C₂F₅)₂, Li(CF₃SO₂)₂N, Li(CF₃SO₂)₃C, LiN(SO₂C₂F₅)₂, lithium alkyl fluorophosphates, organoborate salts, etc., or a combination of two or more thereof. Examples of suitable organoborate salts include, but are not limited to, LIBOB (lithium bis oxalato borate), LiDfOB (lithium difluoro oxalate borate).

In one embodiment, the salt is present in a concentration of about 0.2 to about 3 M; from about 0.5 to about 2 M; even from about 1 to about 1.5 M. In other embodiments, the salt is present in a concentration of from about 0.2 to about 1 M, from about 0.4 to about 0.8 M, even about 0.5 to about 0.6 M. Here, as elsewhere in the specification and claims, individual numerical values can be combined to form additional and/or non-specified ranges.

In one embodiment, the electrolyte may be a solid electrolyte. In one embodiment, the electrolyte composition may comprise (i) an organofunctional silicone or silane compound, (ii) a salt, (iii) at least one polymer binder, and (iv) optionally, a plasticizer. In an embodiment, the polymer binder may be a solid polymer that is a solid when standing alone at room temperature. As a result, the ratio of solid polymer to the other electrolyte components can be selected so as to provide an electrolyte that is a solid at room temperature. A suitable solid polymer is an aprotic polar polymer or aprotic rubbery polymer. Examples of suitable solid polymers include, but are not limited to, polyacrylonitrile (PAN), poly(methyl methacrylate) (PMMA), poly(vinylidene fluoride) (PVDF), poly(vinylidene fluoride-co-hexafluoropropylene), polystyrene, polyvinyl chloride, poly(alkyl methacrylate), poly(alkyl acrylate), styrene butadiene rubber (SBR), poly(vinyl acetate), poly(ethylene oxide) (PEO), or a combination of two or more thereof. The solid polymer electrolyte composition can be generated by preparing a precursor solution that includes one or more organofunctional silicone or silane compounds and a solution that includes at least one solid polymer. The solution that includes the solid polymer can be generated by dissolving the solid polymer in a solvent such as N-methylpyrrolidone (NMP), dimethyl formamide, dimethyl acetamide, tetrahydrofuran, acetonitrile, and/or water. The electrolyte may comprise other additives, siloxanes, and/or silanes. One or more salts can be added to the precursor solution or the salt can be dissolved in a component of the precursor solution before adding the component to the precursor solution. A solid electrolyte can be formed by evaporating the solvent from the precursor solution.

An electrolyte that includes one or more solid polymers can also be prepared by polymerizing a solid polymer in the presence of the silicon compound(s). For instance, a precursor solution can be provided comprising one or more organofunctional silicone or silane compounds, monomers for the solid polymer, and a radical initiator. Suitable radical initiators include, but are not limited to, one or more thermal initiators including azo compounds such as azoisobutyronitrile, peroxide compounds such as benzoylperoxide, and bismaleimide. The precursor solution can optionally be prepared to include one or more additives and/or one or more silanes. One or more salts can be added to the precursor solution, or the salt can be dissolved in a component of the precursor solution before adding the component to the precursor solution. The electrolyte can be formed by polymerizing the monomers.

The electrolyte may further comprise a plasticizer. The plasticizer is not particularly limited and may be selected from any suitable material for use in forming an SPE. Suitable plasticizers include, but are not limited to, alkyl carbonates, cyclic carbonates, glymes, polyalkylene glycol dialkyl ethers, and combinations of two or more thereof.

The electrolyte solution may further comprise a solvent and/or co-solvent. The solvent and/or co-solvent is not particularly limited and may be selected from any suitable solvent and/or co-solvent for use in forming an electrolyte. Suitable solvent and/or co-solvent include, but are not limited to, alkyl carbonates, cyclic carbonates, glymes, polyalkylene glycol dialkyl ethers, or combinations of two or more thereof. A co-solvent refers to a solvent present in a minor amount relative the other solvent(s). This may be less than 50% on a weight basis relative to the total weight of the solvent where the system employs two solvents. Alternatively, in a system with three or more solvents, it can simply mean a lesser wt. % relative to the other solvents.

Carbonates suitable as the solvent and/or co-solvent include, but are not limited to, ethylene carbonate (EC), propylene carbonate (PC), butylene carbonate, dimethyl carbonate (DMC), diethyl carbonate, dipropyl carbonate, and the like, and combinations of two or more thereof. In one embodiment, the solvent and/or co-solvent comprises a 1:1 mixture by weight of EC:DMC.

Examples of suitable glymes include, but are not limited to, dimethoxyethane (C₄H₁₀O₂ or “DME”), diglyme (C₆H₁₄O₃), triglyme (C₈H₁₈O₄), tetraglyme (C₁₀H₂₂O₅), and the like, or a combination of two or more thereof. Examples of suitable polyalkylene glycol dialkyl ethers include, but are not limited to, polyethylene glycol dimethyl ether, polyethylene glycol diethyl ether, polyethylene glycol dipropyl ether, polyethylene glycol dibutyl ether, polyethylene glycol diglycidyl ether, polypropylene glycol dimethyl ether, polypropylene glycol diglycidyl ether, polypropylene glycol/polyethylene glycol copolymer at the end portion of dibutyl ether, polyethylene glycol/polypropylene glycol block copolymer at the end portion of dibutyl ether, and the like, or a combination of two or more thereof. Still other examples of suitable plasticizers include non-aqueous polar solvents such as tetrahydrofuran, 2-methyltetrahydrofuran, 1,3-dioxiran, 4,4-dimethyl-1,3-dioxiran, γ-butyrolactone, and acetonitrile.

In one embodiment, the lithium salt may be present in a range of from about 2 to about 40 wt. % by weight based on the weight of the plasticizer. In another embodiment, the salt is present in an amount of from about 5 to about 20 wt. % based on the weight of the plasticizer.

In one embodiment, the electrolyte composition comprising the organofunctional silicone or silane compound as electrolyte additive with a flash point of greater than 40° C.; greater than 50° C.; greater than 60° C.; greater than 75° C.; greater than 100° C.; greater than 125° C.; or greater than 150° C. In one embodiment, the electrolyte composition has a flash point of from about 50° C. to about 200° C.; from about 75° C. to about 175° C.; from about 100° C. to about 150° C. Here as elsewhere in the specification and claims, numerical values may be combined to form new and non-specified ranges.

The electrolyte comprising the present organofunctional silicone or silane compounds may be used in an electrochemical device. Examples of electromechanical devices that may employ the electrolytes to include, but are not limited to, primary batteries, secondary batteries, capacitors, etc.

Suitable electrochemical devices can have a variety of different configurations including, but not limited to battery, fuel cells, super capacitors, solar cells. In some embodiments, electrochemical device is a battery. The batteries may be of stacked configuration, and “jellyroll” or wound configurations. In some instances, the battery is hermetically sealed. Hermetic sealing can reduce entry of impurities into the battery. As a result, hermetic sealing can reduce active material degradation reactions due to impurities. The reduction in impurity induced lithium consumption can stabilize battery capacity.

The electrolyte can be applied to batteries in the same way as carbonate-based electrolytes. As an example, batteries with a liquid electrolyte can be fabricated by injecting the electrolyte into a spiral wound cell or prismatic type cell. The electrolyte can be also coated onto the surface of electrode substrates and assembled with a porous separator to fabricate a single or multi-stacked cell that can enable the use of flexible packaging.

The electrolyte composition containing a solid or liquid media described above can also be applied to electrochemical devices in the same way as solid carbonate-based electrolytes. For instance, a precursor solution having components for a solid electrolyte can be applied to one or more substrates. Suitable substrates include, but are not limited to, anode substrates, cathode substrates and/or separators such as a polyolefin separator, nonwoven separator or polycarbonate separator. The precursor solution is converted to a solid or gel electrolyte such that a film of the electrolyte is present on the one or more substrates. In some instances, the substrate is heated to solidify the electrolyte on the substrate. An electrochemical cell can be formed by positioning a separator between an anode and a cathode such that the electrolyte contacts the anode and the cathode.

An example of a suitable secondary lithium ion battery construction includes the electrolyte activating one or more cathodes and one or more anodes. Cathodes may include one or more active materials such as lithium, elemental lithium foil, lithium metal oxide, LiₓVO_{y}, LiCoO₂, LiNiO₂, LiNi₁₋ₓCo_{y}Me_{z}O₂, LiMn_{0.05}Ni_{0.5}O₂, LiMn_{0.3}Co_{0.3}Ni_{0.3}O₂, LiFePO₄, LiMn₂O₄, LiFeO₂, LiMc_{0.5}Mn_{1.5}O₄, vanadium oxide, carbon fluoride and mixtures thereof wherein Me is Al, Mg, Ti, B, Ga, Si, Mn, Zn, and combinations thereof, and Mc is a divalent metal such as Ni, Co, Fe, Cr, Cu, and combinations thereof. Anodes may include one or more active materials such as graphite, soft carbon, hard carbon, Li₄Ti₅O₁₂, tin alloys, silica alloys, intermetallic compounds, lithium metal, lithium metal alloys, and combinations thereof. An additional or alternate anode active material includes a carbonaceous material or a carbonaceous mixture. For instance, the anode active material can include or consist of one, two, three or four components selected from the group consisting of: graphite, carbon beads, carbon fibers, and graphite flakes. In some instances, the anode includes an anode substrate and/or the cathode includes a cathode substrate. Suitable anode substrates include, but are not limited to, lithium metal, titanium, a titanium alloy, stainless steel, nickel, copper, tungsten, tantalum or alloys thereof. Suitable cathode substrates include, but are not limited to, aluminum, stainless steel, titanium, or nickel substrates.

In some embodiments, the battery may be fabricated by the following procedure. The electrodes of the battery are prepared by coating of slurry on current collectors. The current collector may be of aluminum or copper. The slurry is prepared by mixing active material, conductive agent and binder. The active material described above can be varied between 50-70 wt. %, the conducting agent based on carbon can be varied between 10-20 wt. % and the binder can be varied between 5-10 wt. %. The mixing of these ingredients in a suitable organic or aqueous media results in a slurry which can be coated on a metal foil which act as a current collector. The cathode slurry in one embodiment is coated on aluminum sheet and the anode slurry is coated on copper sheet. The sheets are then dried and processed and cut into desired dimension to fabricate cells.

In one embodiment coin cells of 2032 were fabricated inside argon filled glove box and tested for their electrochemical performance between a desired potential difference. The potential difference can be set between 0.01 to 5.4 V, 0.01 to 3.0 V, 0.01 to 6 V, or between 2.2 V to 4.2 V

Aspects of the invention may be further understood in view of the following examples. The examples are only for purposes of illustrating embodiments or aspects of the invention, but the invention is not limited to such examples. The term “electrolyte” as used hereinafter in all the examples, may include an electrolyte additive, a co-solvent, or a solvent.

### EXAMPLES

### Example 1: Synthesis of Tetrahydrofurfuryl Functional Silane

Chlorotrimethylsilane (100 gm, 0.92 mol) was mixed with anhydrous toluene (100 ml) in a 500 ml 3 neck round bottom flask. To this solution, a pre-mixture of trimethylamine (258.7 ml, 1.84 mol) and tetrahydrofuryl alcohol (90 ml, 0.92 mol) was added dropwise at 0° C. under nitrogen atmosphere. After completion of the addition, the reaction mixture was allowed to stir at room temperature and stirred for 12 hours under nitrogen atmosphere. The obtained white precipitate was dissolved in water (500 ml). An aqueous solution was extracted with hexane (4×250 ml). Finally, the organic fraction was dried with anhydrous sodium sulphate powder, and the solvent was evaporated using rotary evaporator under reduced pressure. The obtained crude product was further purified by double distillation under reduced pressure to obtain a colorless liquid (Electrolyte 1). The product was characterized by NMR, GC-MS/FID techniques. The product was stored inside a glove box under argon atmosphere.

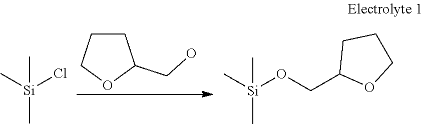

### Example 2 (Comparative): Synthesis of Nitrile Functional Silane

Chlorotrimethylsilane (125 gm, 1.15 mol) was mixed with anhydrous toluene (125 ml) in a 500 ml 3 neck round bottom flask. To this solution, a pre-mixture of trimethylamine (323 ml, 2.3 mol) and 3-Hydroxy propionitrile (78.54 ml, 1.15 mol) was added dropwise at 0° C. under nitrogen atmosphere. After completion of the addition, the reaction mixture was allowed to stir at room temperature and stirred for 12 hours under nitrogen atmosphere. The obtained white precipitate was dissolved in water (500 ml). An aqueous solution was further extracted with hexane (4×250 ml). Finally, the organic fraction was dried with anhydrous sodium sulphate powder, and the solvent was evaporated using rotary evaporator under reduced pressure. The obtained crude product was further purified by double distillation under reduced pressure to obtain a colorless liquid (Electrolyte 2). The product was stored inside a glove box under argon atmosphere.

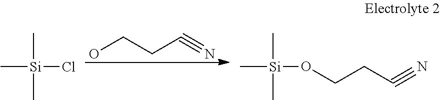

### Example 3 (Comparative): Synthesis of Ethylene Carbonate Functional Silane

Chlorotrimethylsilane (20 gm, 0.18 mol) was mixed with anhydrous toluene (20 ml) in a 250 ml 3 neck round bottom flask. To this solution, a pre-mixture of trimethylamine (52 ml, 0.36 mol) and glycerol 1,2-carbonate (21.7 ml, 0.18 mol) was added dropwise at 0° C. under nitrogen atmosphere. After completion of the addition, the reaction mixture was allowed to stir at room temperature and stirred for 12 hours under nitrogen atmosphere. The obtained white precipitate was dissolved in water (250 ml). An aqueous solution was further extracted with hexane (4×100 ml). Finally, the organic fraction was dried with anhydrous sodium sulphate powder, and the solvent was evaporated using rotary evaporator under reduced pressure. The obtained crude product was further purified by double distillation under reduced pressure to get colorless liquid (Electrolyte 3). The product was stored inside a glove box under argon atmosphere.

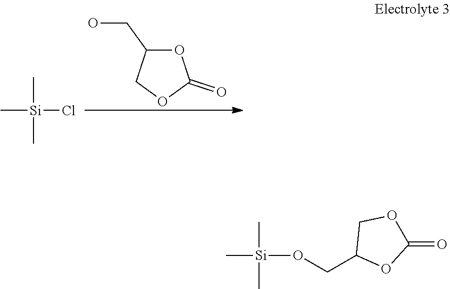

### Example 4: Synthesis of Fluoro Functional Silane

In step 1, allyloxy (diethylene oxide), methyl ether (149 gm, 1.34 mol) was taken in a 250 ml round bottom flask and the solution was heated to 85° C. To this solution, Karstedt's catalyst (42 ml, 10 ppm) was added, followed by dropwise addition of chlorodimethylsilane (125 ml, 1.12 mol). It was observed that the reaction was exothermic up to 110° C. during chlorodimethylsilane addition. After completion of the addition, the reaction mixture was stirred at the same temperature for 1 hour. Further, the reaction mixture was monitored using ¹HNMR analysis, which confirms the complete consumption of hydride in the reaction. After completion of the reaction, the resulting crude product was further purified by distillation under reduced pressure.

In step 2, allyl glycidyl ether functional silane (step 1 product, 228 gm, 0.89 mol) was mixed with anhydrous toluene solvent (228 ml) in a 1 L round bottom flask. To this solution, a pre-mixture of trimethylamine (251 ml, 1.78 mol) and 2,2,2-trifluoroethanol (64.3 ml, 0.89 mol) was added dropwise at 0° C. under nitrogen atmosphere. After completion of the addition, the reaction mixture was allowed to stir at room temperature and stirred for 12 hours under nitrogen atmosphere. The obtained white precipitate was dissolved in water (500 ml). An aqueous solution was further extracted with hexane (4×250 ml). Finally, the organic fraction was dried with anhydrous sodium sulphate powder and the solvent was evaporated using a rotary evaporator under reduced pressure. The obtained crude product was further purified by double distillation under reduced pressure to get colorless liquid (Electrolyte 4). The product was stored inside a glove box under argon atmosphere.

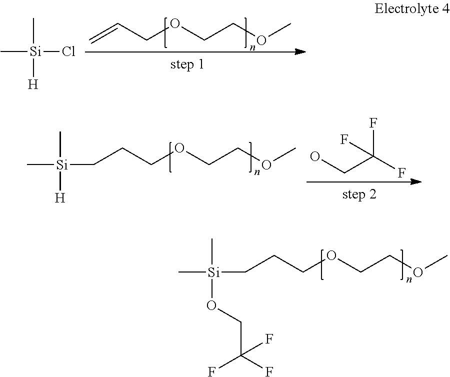

### Example 5: Synthesis of Nitrile Functional Carbosilane

In step 1, Chloro(dimethyl)vinylsilane (69.6 gm, 0.57 mol) was taken in a 250 ml round bottom flask and the solution was heated to 75° C. To this solution, Karstedt's catalyst (65 l, 10 ppm) was added, followed by dropwise addition of chlorodimethylsilane (61.24 ml, 0.63 mol). It was observed that the reaction was exothermic up to 100° C. during chlorodimethylsilane addition. After completion of the addition, the reaction mixture was stirred at the same temperature for 1 hour. Further, the reaction mixture was monitored using ¹HNMR analysis, which confirms the complete consumption of hydride in the reaction. After completion of the reaction, the crude product was taken as such for next step without any purification.

In step 2, dichlorocarbosilane (step 1 product, 107 gm, 0.49 mol) was mixed with anhydrous toluene solvent (107 ml) in a 1 L round bottom flask. To this solution, a pre-mixture of trimethylamine (280 ml, 2.3 mol) and 3-Hydroxy propionitrile (68 ml, 0.99 mol) was added dropwise at 0° C. under nitrogen atmosphere. After completion of the addition, the reaction mixture was allowed to stir at room temperature and stirred for 12 hours under nitrogen atmosphere. The obtained white precipitate was filtered off and further washed with anhydrous hexane (4×250 ml). Finally, the organic fraction was dried with anhydrous sodium sulphate powder and the solvent was evaporated using rotary evaporator under reduced pressure. The obtained crude product was further purified by double distillation under reduced pressure to obtain a colorless liquid (Electrolyte 5). The product was stored inside a glove box under argon atmosphere.

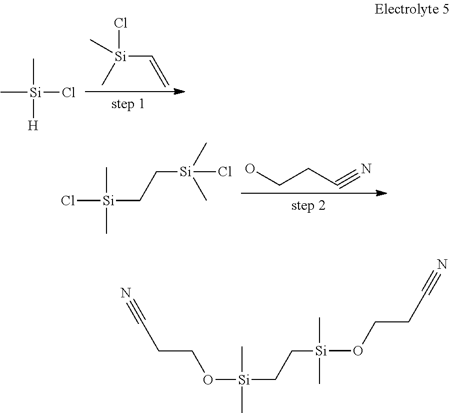

### Example 6: Synthesis of Trifluoro Ether Functional Carbosiloxane

Dichloro carbosilane (step 1 product Example 5, 107 gm, 0.49 mol) was mixed with anhydrous toluene solvent (107 ml) in a 1 L round bottom flask. To this solution, a pre-mixture of trimethylamine (280 ml, 2.3 mol) and 2,2,2-Trifluoroethanol (99 ml, 0.99 mol) was added dropwise at 0° C. under nitrogen atmosphere. After completion of the addition, the reaction mixture was allowed to stir at room temperature and stirred for 12 hours under nitrogen atmosphere. The obtained white precipitate was filtered off and further washed with anhydrous hexane (4×250 ml). Finally, the organic fraction was dried with anhydrous sodium sulphate powder and the solvent was evaporated using a rotary evaporator under reduced pressure. The obtained crude product was further purified by double distillation under reduced pressure to get a colorless liquid (Electrolyte 6). The product was stored inside a glove box under argon atmosphere.

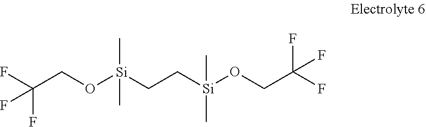 [SMILES: C[Si](C)(CC[Si](C)(C)OCC(F)(F)F)OCC(F)(F)F]

### Example 7: Synthesis of Halogenated Aryl Group Functional Carbosiloxane

Dichloro carbosilane (step 1 product Example 5, 107 gm, 0.49 mol) was mixed with anhydrous toluene solvent (107 ml) in a 1 L round bottom flask. To this solution, a pre-mixture of trimethylamine (280 ml, 2.3 mol) and 4-(Trifluoromethyl)benzyl alcohol (174.2 ml, 0.99 mol) was added dropwise at 0° C. under nitrogen atmosphere. After completion of the addition, the reaction mixture was allowed to stir at room temperature and stirred for 12 hours under nitrogen atmosphere. The obtained white precipitate was filtered off and further washed with anhydrous hexane (4×250 ml). Finally, the organic fraction was dried with anhydrous sodium sulphate powder and the solvent was evaporated using a rotary evaporator under reduced pressure. The obtained crude product was further purified by double distillation under reduced pressure to obtain a colorless liquid (Electrolyte 7). The product was stored inside a glove box under argon atmosphere.

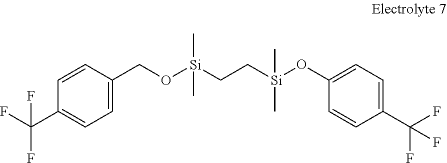 [SMILES: C[Si](C)(CC[Si](C)(C)Oc1ccc(C(F)(F)F)cc1)OCc1ccc(C(F)(F)F)cc1]

### Example 8: Synthesis of Polyether Functional Carbosiloxane

Dichloro carbosilane (step 1 product Example 5, 107 gm, 0.49 mol) was mixed with anhydrous toluene solvent (107 ml) in a 1 L round bottom flask. To this solution, a pre-mixture of trimethylamine (280 ml, 2.3 mol) and 2-(2-Methoxyethoxy)ethanol (119 ml, 0.99 mol) was added dropwise at 0° C. under nitrogen atmosphere. After completion of the addition, the reaction mixture was allowed to stir at room temperature and stirred for 12 hours under nitrogen atmosphere. The obtained white precipitate was filtered off and further washed with anhydrous hexane (4×250 ml). Finally, the organic fraction was dried with anhydrous sodium sulphate powder, and the solvent was evaporated using rotary evaporator under reduced pressure. The obtained crude product was further purified by double distillation under reduced pressure to get colorless liquid (Electrolyte 8). The product was stored inside a glove box under argon atmosphere.

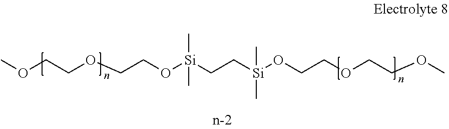

### Example 9: Synthesis of Polyether and Nitrile Functional Carbosiloxane

In step 1, Chloro(dimethyl)vinylsilane (15 gm, 0.125 mol) was mixed with anhydrous toluene solvent (45 ml) in a 500 ml round bottom flask. To this solution, a pre-mixture of trimethylamine (25.16 ml, 0.25 mol) and 2-(2-Methoxyethoxy)ethanol (14.93 gm, 0.12 mol) was added dropwise at 0° C. under nitrogen atmosphere. After completion of the addition, the reaction mixture was allowed to stir at room temperature and stirred for 12 hours under nitrogen atmosphere. The obtained white precipitate was filtered off and further washed with anhydrous hexane (4×125 ml). Finally, the organic fraction was dried with anhydrous sodium sulphate powder, and the solvent was evaporated using rotary evaporator under reduced pressure. The obtained crude product was taken as such for next step without any further purification.

In step 2, above product (step 1 product, 15 gm, 0.073 mol) was taken in a 100 ml round bottom flask and the solution was heated to 75° C. To this solution, Karstedt's catalyst (13 mg, 10 ppm) was added, followed by dropwise addition of chlorodimethylsilane (10.5 ml, 0.073 mol). It was observed that the reaction was exothermic up to 85° C. during chlorodimethylsilane addition. After completion of the addition, the reaction mixture was stirred at the same temperature for 1 hour. Further, the reaction mixture was monitored using ¹HNMR analysis, which confirms the complete consumption of hydride in the reaction. After completion of the reaction, the crude product was taken as such for next step without any purification.

In step 3, above step 2 product (22 gm, 0.07 mol) was mixed with anhydrous toluene solvent (70 ml ml) in a 500 ml round bottom flask. To this solution, a pre-mixture of trimethylamine (20 ml, 0.14 mol) and 3-Hydroxy propionitrile (5.54 gm, 0.08 mol) was added dropwise at 0° C. under nitrogen atmosphere. After completion of the addition, the reaction mixture was allowed to stir at room temperature and stirred for 12 hours under nitrogen atmosphere. The obtained white precipitate was dissolved in water (500 ml). An aqueous solution was further extracted with hexane (4×250 ml). Finally, the organic fraction was dried with anhydrous sodium sulphate powder and the solvent was evaporated using a rotary evaporator under reduced pressure. The obtained crude product was further purified by fractional distillation under reduced pressure to get colorless liquid (Electrolyte 9). The product was stored inside a glove box under argon atmosphere.

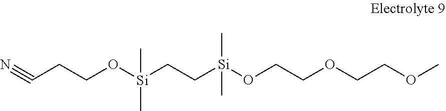 [SMILES: COCCOCCO[Si](C)(C)CC[Si](C)(C)OCCC#N]

### Example 10: Synthesis of Sulfone and Nitrile Functional Siloxane

In step 1, allyl cyanide (20 ml, 0.29 mol) was taken in a 250 ml round bottom flask and the solution was heated to 80° C. To this solution, Karstedt's catalyst (20 mg, 10 ppm) was added, followed by dropwise addition of 1,1,3,3-Tetramethyldisiloxane (20 gm, 0.14 mol). It was observed that the reaction was exothermic up to 85° C. during hydride addition. After completion of the addition, the reaction mixture was stirred at the same temperature for 1 hour. Further, the reaction mixture was monitored using ¹HNMR analysis, which confirms the complete consumption of hydride in the reaction. After completion of the reaction, the crude product was purified by stripping mixture to remove excess allyl cyanide and taken the product for next step

In step 2, above step 2 product (15 gm, 0.07 mol) was taken in a 250 ml round bottom flask and the solution was heated to 85° C. To this solution, Karstedt's catalyst (12 mg, 10 ppm) was added, followed by dropwise addition of allyl methyl sulfone (8.37 gm, 0.07 mol). It was observed that the reaction was exothermic up to 92° C. during hydride addition. After completion of the addition, the reaction mixture was stirred at the same temperature for 1 hour. Further, the reaction mixture was monitored using ¹HNMR analysis, which confirms the complete consumption of hydride in the reaction. After completion of the reaction obtained crude product was further purified by fractional distillation under reduced pressure to get colorless liquid (Electrolyte 10). The product was stored inside a glove box under argon atmosphere.

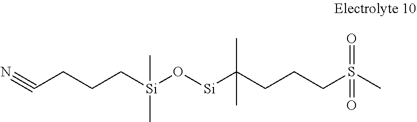

Physical properties of the electrolyte additives are shown in Table 1. The term “electrolyte” in Tables 1, 2, 3 refers to the electrolyte additive, a co-solvent, or a solvent.

TABLE 1
Physical properties of electrolyte additives

| | | | | Solubility |
|---|---|---|---|---|
| | | Purity | Viscosity | in |
| Examples | Structure | (%)* | cPs | Lithium salt |
| Electrolyte 1 | 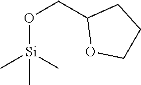 | 99.5 | <5 | Up to 13 wt. % of LiPF₆ |
| Electrolyte 2 | 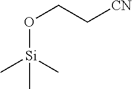 | 98.9 | <5 | Up to 11 wt. % of LiPF₆ |
| Electrolyte 3 | 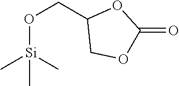 | 99.9 | <10 | Up to 13 wt. % of LiPF₆ |
| Electrolyte 4 | 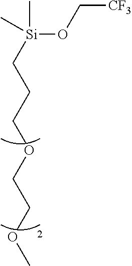 [SMILES: COCCOCCC[Si](C)(C)OCC(F)(F)F] | 99.7 | <10 | Up to 13 wt. % of LiPF₆ |
| Electrolyte 5 | 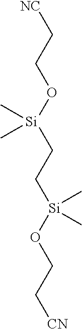 | 98.5 | 15 | Up to 12 wt. % of LiPF₆ |
| Electrolyte 6 | 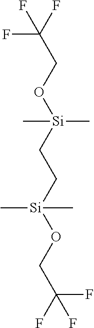 [SMILES: C[Si](C)(CC[Si](C)(C)OCC(F)(F)F)OCC(F)(F)F] | 99 | 15 | Up to 12 wt. % of LiPF₆ |
| Electrolyte 7 | 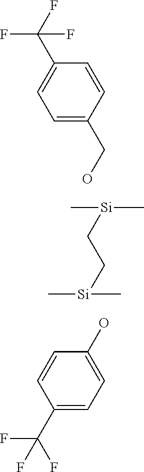 | 98.5 | 20 | Up to 12 wt. % of LiPF₆ |
| Electrolyte 8 | 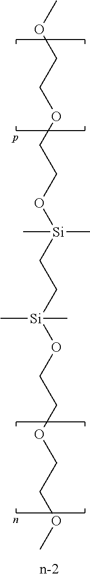 | 99 | 40 | Up to 12 wt. % of LiPF₆ |
| Electrolyte 9 | 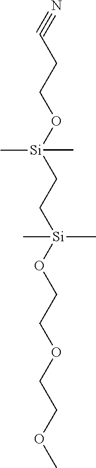 | 90 | 30 | Up to 12 wt. % of LiPF₆ |
| Electrolyte 10 | 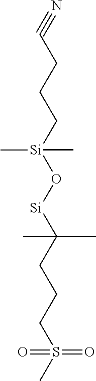 | 90 | 40 | Up to 12 wt. % of LiPF₆ |

*For electrolytes 1-8, the purity was measured by GC-FID and the purity for electrolyte samples 9-10 were determined by 1H-NMR.

The electrolyte additives 1-5 were also analyzed for their water content, chloride content and flash point. The observed values of water content was in the range of 0.03-0.28 wt. %. The chloride content was noted to be less than 166 ppm and flash point of the electrolytes was noted to be in the range of 56-186° C., which are also shown in Table 2.

TABLE 2
Water content, chloride content and flash point analyses
of electrolyte additive

| | | Water | Chloride | Flash |
|---|---|---|---|---|
| | | content | content | point |
| Examples | Structure | in Wt. % | in ppm | /° C. |
| Electrolyte 1 | 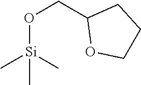 | 0.03 | 166 | 56 |
| Electrolyte 2 | 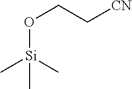 | 0.06 | <25 | 67 |
| Electrolyte 3 | 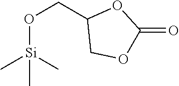 | 0.07 | <25 | 138 |
| Electrolyte 4 | 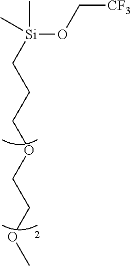 [SMILES: COCCOCCC[Si](C)(C)OCC(F)(F)F] | 0.28 | <25 | 126 |
| Electrolyte 5 | 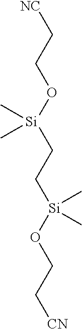 | 0.065 | <25 | 186 |

### Electrochemical Measurements of Developed Molecules in Coin Cell

The half cells were fabricated using the active material graphite, carbon black, and PVDF (70:20:10), and the slurry was prepared by addition of N-methyl pyrrolidone. The as prepared slurry was coated on the copper foil and dried under vacuum for 6 h at 60° C.

The electrolyte additives were added in 1 wt. % with respect to reference electrolyte LiPF₆/EC/EMC. In the case of half cells with reference electrolyte, the retention in specific capacity at high 3 C rate after 50 cycles was noted to be only 10% of initial specific capacity. Also, the CV curves showed the presence of SEI layer formation in the first cycle and continued steady fall in the current with the redox cycling reactions, suggesting that the electrochemical stability was not well maintained. With the addition of the electrolyte additives 4 and 5, the retention in specific capacity after 50 cycles was noted to be 20 and 25% respectively, which were higher compared to the bare reference electrolyte. In addition, the CV of the cell with electrolyte 5 as additive, showed well overlapped redox CV curves, suggesting that the electrochemical stability was achieved after the first cycle. The internal resistance was also noted to be lower with electrolyte 5 compared to other additives as well as electrolyte without additives.

With electrolyte 6, the electrochemical cycling stability was tested at low current density of 0.3 C rate. The cell showed excellent cycling stability over 50 cycles with retention in capacity of 18% compared to initial cycle. In addition, the specific capacity between 4^{th}-49^{th} cycle was noted to be above 75%, indicating that the presence of electrolyte 6 aids in retention of specific capacity.

TABLE 3
Electrochemical results of electrolyte formulations

| | Initial | | Final | | Resistance | | |
|---|---|---|---|---|---|---|---|
| | capacity | Initial | capacity | Final | after 10 | % | |
| Electrolyte | (mAh/g) | Voltage | (mAh/g) | voltage | cycles | Retention | |
| Formulation | (C Rate) | (V) | (C rate) | (V) | (mΩ) | capacity | Observation |
| Ref. 1* | 325.7 (3 C) | 1.51 | 32 (3 C) | 0.7 | 110 | 10 | No additive |
| Ref. 1 + 1% | 370 (3 C) | 1.92 | 85.3 | 0.87 | 56 | 23 | Stable at high |
| Ref. 2** | | | | | | | rate; long cycle |
| LiPF₆/EC/EMC | 335 (3 C) | 1.71 | 32 (3 C) | 0.8 | 96 | 9 | weak retention |
| (1M) + 1% | | | | | | | & not at stable |
| Electrolyte 2 | | | | | | | high rate |
| LiPF₆/EC/EMC | 272.9 (3 C) | 1.71 | 52.7 (3 C) | 1.3 | 78 | 20 | Stable at High |
| (1M) + 1% | | | | | | | rate; long cycle |
| Electrolyte 4 | | | | | | | |
| LiPF₆/Electrolyte | 369 (3 C) | 2.3 | 54.3 | 0.8 | 65 | 14.7 | No electrolyte |
| 4 (1M) | | | | | | | |
| LiPF₆/EC/EMC | 386.9 (3 C) | 2.1 | 96.9 (3 C) | 1.9 | 46.8 | 25 | Stable at high |
| (1M) + 1% | | | | | | | rate; long cycle |
| Electrolyte 5 | | | | | | | |
| LiPF₆/EC/EMC | 365 (0.3 C) | 1.81 | 66.13 | 1.41 | Not | 18 | Stable over |
| (1M) + 1% | | | | | determined | | long number of |
| Electrolyte 6 | | | | | | | cycles after |
| | | | | | | | stabilization; |
| | | | | | | | not tested at |
| | | | | | | | high rate |
| LiPF₆/EC/EMC | 378 (3 C) | 2.7 | 35.4 | 0.9 | 67 | 9.3 | Low retention |
| (1M) + 1% | | | | | | | in capacity |
| Electrolyte 9 | | | | | | | |
| LiPF₆/EC/EMC | 341(3 C) | 2.9 | 98.3 | 1.1 | 75 | 28.8 | High retention |
| (1M) + 1% | | | | | | | in capacity |
| Electrolyte 10 | | | | | | | |

*Ref. 1 is a control electrolyte sample purchased from Sigma-Aldrich (LiPF₆/EC/EMC (1M))
**Ref. 2 is 1,3-bis(cyanopropyl)tetramethyldisiloxan purchased from Gelest.

Embodiments of the invention have been described above and, obviously, modifications and alterations may occur to others upon the reading and understanding of this specification. The claims as follows are intended to include all modifications and alterations insofar as they come within the scope of the claims or the equivalent thereof.

1. An electrolyte comprising an organofunctional silicone or silane compound of the formula (I): 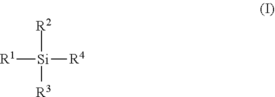
where R¹, R², and R³ are each independently selected from a C1-C10 alkyl, a C1-C10 substituted alkyl, a C5-C30 cyclic alkyl, a C6-C30 aryl, a C2-C10 ether, a group of formula (ia), and a group of formula (ib); and R⁴ is selected from a group of formula (ia) or (ib);
where formula (ia) and (ib) are represented by the formulas:
Vₑ[(CH₂)_{f}]X (ia)
W_{g}[(CH₂)ₕ(Y)ᵢ(Z)ⱼ(CH₂)ₖ(CH₂O)ₗ]X (ib)
where V is a heteroatom selected from oxygen, nitrogen, and sulfur;
W is a heteroatom selected from oxygen, nitrogen, and sulfur;
Z is a heteroatom selected from oxygen, nitrogen, and sulfur;
e is 0 or greater;
f is 0 or greater, where (e+f) is greater than 1;
g, h, i, j, k, and l are each independently 0 or greater, where (g+h+i+j+k+l) is greater than 0;
Y is selected from an alkyl silyl group optionally substituted with a halogen atom; and
X is selected from (i) a C1-C10 alkyl group when 1 is greater than 0, or (ii) an organic polar group;
with the proviso that when R¹, R², and R³ are each selected from a C1-C10 alkyl and R⁴ is a group (ia) then X is selected from an amide, a thioamide, an isocyanate, an isothiocyanate, a thiocyanate, a sulfone, a sulfoxide, a sulfonate, a fluoroalkyl, a sulfamide, a sulfonoamide, a carbamide, a thiocarbamide, an imide, a sulfonoimide, a nitro, an ether, an oxolane, a furan, a lactone, a thiolane, a thiophene, a pyridine, a fluoroalkyl substituted phenyl, a pyrrolidone, or a pyrrole.

2. The electrolyte of claim 1, wherein, when not subject to the proviso, the organic polar group X is selected from a group selected from a nitrile, an amide, a thioamide, an isocyanate, an isothiocyanate, a thiocyanate, a sulfone, a sulfoxide, a sulfonate, a fluoroalkyl, a sulfamide, a sulfonoamide, a carbamide, a thiocarbamide, an imide, a sulfonoimide, a nitro, an ether, an oxolane, a furan, a lactone, a dioxolanone, a thiolane, a thiophene, a pyridine, a fluoroalkyl substituted phenyl, a pyrrolidone, a pyrrole, or a combination of two or more thereof.

3. The electrolyte of claim 1, wherein the organofunctional silicone or silane compound is of the formula (I-A): 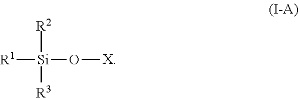
wherein R¹, R², and R³ are a C1-C10 alkyl or a C1-C10 substituted alkyl.

4. The electrolyte of claim 1, wherein R⁴ of the organofunctional silicone or silane compound of the formula I-A is a furfuryl group, provided that R¹, R², and R³ are other than a polyalkylene ether group.

5. The electrolyte of claim 1, wherein the organofunctional silicone or silane compound is of the formula (I-B):

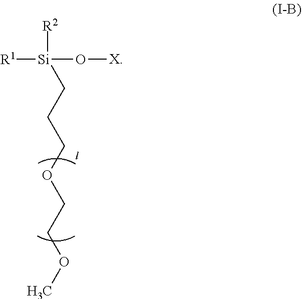

6. The electrolyte of claim 5, wherein X, R¹, and R² are other than a furfuryl group.

7. The electrolyte of claim 1, wherein the organofunctional silicone or silane compound of the formula (I) is a carbosilane.

8. The electrolyte of claim 1, wherein the organofunctional silicone or silane compound is of the formula (I-C): 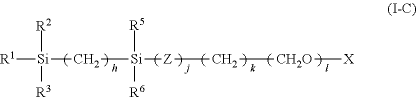
where R¹, R², and R³ are as described in claim 1; R⁵ and R⁶ are independently a C1-C10 alkyl, a C1-C10 substituted alkyl, or a halogen atom; and Z, X, h, j, k, and l are as described in claim 1.

9. The electrolyte of claim 1, wherein the organofunctional silicone or silane compound is of the formula (I-D): 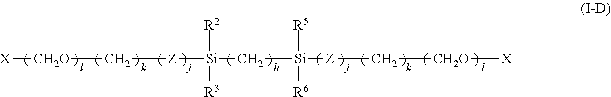
wherein the Z groups can be the same or different from one another, the X groups can be the same or different from one another, the j values can be the same or different from one another, the k values can be the same or different from one another, and the l values can be the same or different from one another, and where R¹, R², and R³ are as described in claim 1; R⁵ and R⁶ are independently a C1-C10 alkyl, a C1-C10 substituted alkyl, or a halogen atom; and Z, X, h, j, k, and l are as described in claim 1.

10. The electrolyte of claim 9, wherein the organofunctional silicone or silane compound is of the formula (I-F): 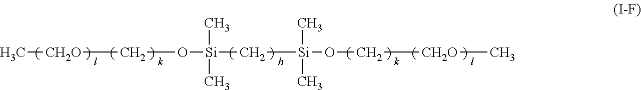
wherein h, k, and l are as described in claim 1.

11. The electrolyte of claim 1, wherein the organofunctional silicone or silane compound is of the formula (I-G): 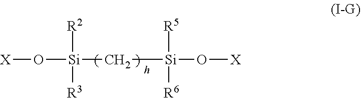
wherein R¹, R², and R³ are as described in claim 1; R⁵ and R⁶ are independently a C1-C10 alkyl or substituted alkyl or a halogen atom; and X, and h are as described in claim 1.

12. The electrolyte of claim 1, wherein the organofunctional silicone or silane compound is of the formula (I-H): 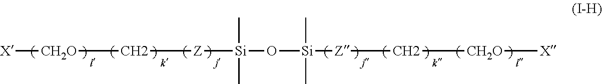
wherein the X′ and X″ groups are chosen from X and are different from one another, the Z′ and Z″ groups are chosen from Z and can be the same or different from one another, the j′ and j″ are chosen from j and values can be the same or different from one another, the k′ and k″ are chosen from k and values can be the same or different from one another, and the l′ and l″ are chosen from l and values can be the same or different from one another, wherein Z, X, j, k, and l are as described in claim 1.

13. The electrolyte of claim 12, wherein X′ and X″ are each independently selected from (i) a C1-C10 alkyl group when l′ and l″ is greater than 0, or from the organic polar group X.

14. The electrolyte of claim 13, wherein the organofunctional silicone or silane compound is of the formula (I-I): 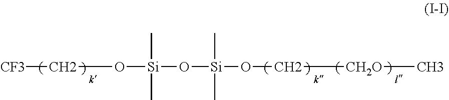
wherein k, and l are as described in claim 1.

15. The electrolyte of claim 1, wherein the organofunctional silicone or silane compound is of the formula (I-J): 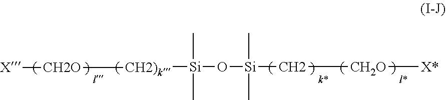
wherein the X′″ and X* groups are chosen from X and are different from one another, the k′″ and k* are chosen from k and values can be the same or different from one another, and the l′″ and l* are chosen from l and values can be the same or different from one another, and wherein X, k, and l are as described in claim 1.

16. The electrolyte of claim 15, wherein X′″ and X* is selected from (i) a C1-C10 alkyl group when l′″ and l* is greater than 0, or from (ii) the organic polar X.

17. The electrolyte of claim 15, wherein the organofunctional silicone or silane compound is of the formula (I-K): 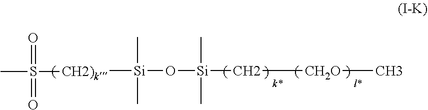
wherein k′″ and k* are chosen from k and values can be the same or different from one another, and the l* is chosen from 1, and k, and l are as described in claim 1.

18. The electrolyte of claim 1, wherein the organic polar group is independently selected from a group of the formula (X-i to X-xii) 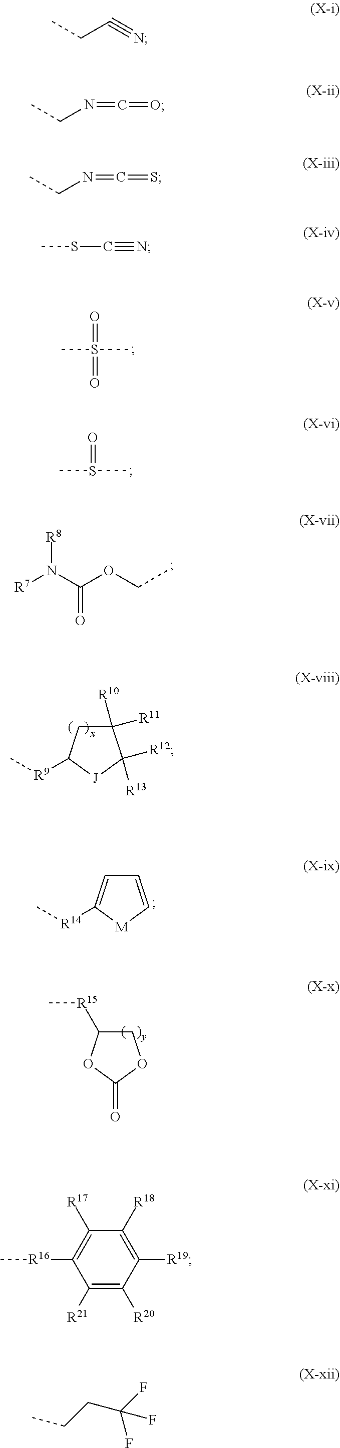
where R⁹, R¹⁴, R¹⁵, and R¹⁶ are independently selected from an organic spacer;
R⁷ and R⁹ are independently selected from H or a C1-C6 alkyl;
R¹⁰, R¹¹, R¹², and R¹³ are independently selected from H, a C1-C6 alkyl, or a halogen atom (e.g., F);
x is 1-10;
y is 1-10;
J and M are independently selected from O, S, or N;
R¹⁷, R¹⁸, R¹⁹, R²⁰, and R²¹ are independently selected from H, a C1-C6 alkyl, and a C1-C6 fluoroalkyl, with the proviso that at least one of R¹⁷, R¹⁸, R¹⁹, R²⁰, and R²¹ is a fluoroalkyl.

19. The electrolyte of claim 1, wherein the organic polar group is independently selected from a group of the formula (X-ii to X-ix, and/or X-xi): 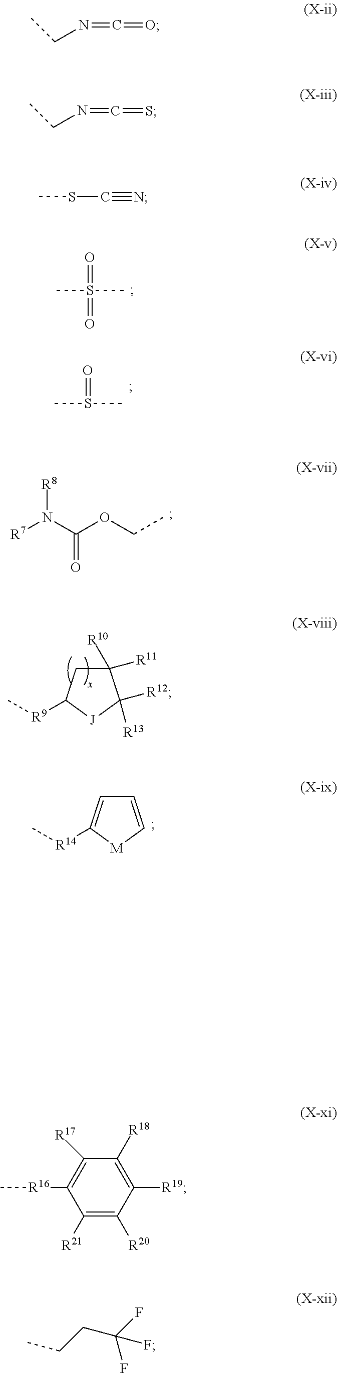
where R⁹, R¹⁴, R¹⁵, and R¹⁶ are independently selected from an organic spacer, e.g., a C1-C6 alkyl;
R⁷ and R⁹ are independently selected from H or a C1-C6 alkyl;
R¹⁰, R¹¹, R¹², and R¹³ are independently selected from H, a C1-C6 alkyl, or a halogen atom (e.g., F);
x is 1-10;
y is 1-10;
J and M are independently selected from O, S, or N;
R¹⁷, R¹⁸, R¹⁹, R²⁰, and R²¹ are independently selected from H, a C1-C6 alkyl, and a C1-C6 fluoroalkyl, with the proviso that at least one of R¹⁷, R¹⁸, R¹⁹, R²⁰, and R²¹ is a fluoroalkyl.

20. The electrolyte of claim 1, wherein unless subject to the proviso, X is an organic polar group independently selected from:

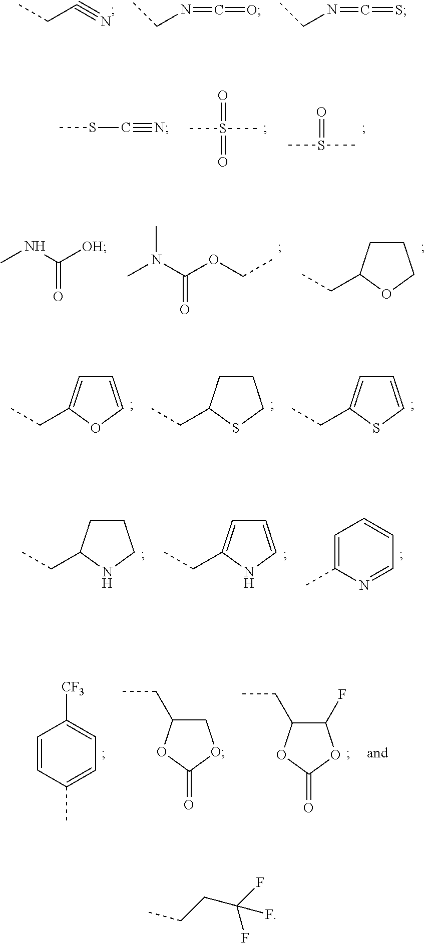

21. The electrolyte of claim 1, wherein the organofunctional silicone or silane compound is an electrolyte additive, a solvent, and/or a co-solvent.

22. The electrolyte of claim 1, wherein the organofunctional silicone or silane compound is an electrolyte additive disposed in a solvent selected from a group consisting of toluene, xylene, hexane, DMF, THF, DCM, DMSO, NMP, and ethyl acetate.

23. An electrolyte composition comprising (i) an electrolyte of claim 1; and (ii) a salt.

24. The electrolyte composition of 23, wherein the salt is a lithium salt.

25. The electrolyte composition of claim 23, wherein the lithium salt is chosen from LiClO₄, LiCF₃SO₃, LiBF₄, LiPF₆, LiAsF₆, LiN(SO₂C₂F₅)₂, Li(CF₃SO₂)₂N, Li(CF₃SO₂)₃C, LiN(SO₂C₂F₅)₂, lithium alkyl fluorophosphates, organoborate salts, or a combination of two or more thereof.

26. The electrolyte composition of claim 23, further comprising (iii) a solvent.

27. The electrolyte composition of claim 26, wherein the solvent is selected from an alkyl carbonate, a cyclic carbonate, a glyme, a polyalkylene glycol dialkyl ether, or a combination of two or more thereof.

28. The electrolyte composition of claim 26, further comprising (iv) a cosolvent.

29. The electrolyte composition of claim 28, wherein the cosolvent is selected from an alkyl carbonate, a cyclic carbonate, a glyme, a polyalkylene glycol dialkyl ether, or a combination of two or more thereof.

30. The electrolyte composition of claim 23, wherein the electrolyte is a solid electrolyte, a liquid electrolyte, or a gel electrolyte.

31. The electrolyte composition of claim 30 further comprising (v) a plasticizer wherein the plasticizer is chosen from an alkyl carbonate, a cyclic carbonate, a glyme, a polyalkylene glycol dialkyl ether, or a combination of two or more thereof.

32. The electrolyte composition of claim 23, wherein the organofunctional silicone or silane compound is present in an amount of from about 0.5 to about 5 wt. % based on the total weight of the composition.

33. The electrolyte composition of claim 23, wherein the organofunctional silicone or silane compound is present in an amount of from about 1 to about 3 wt. % based on the total weight of the composition.

34. The electrolyte composition of claim 23, wherein the electrolyte composition has a flash point of from about 50° C. to about 200° C.

35. An electrochemical device comprising the electrolyte composition of claim 23.

36. A method of making an electrolyte composition comprising adding an electrolyte additive of claim 1 to a salt solution.

37. The method of claim 36, wherein the electrolyte additive is added in an amount of from about 0.5 wt. % to about 5 wt. % based on the weight of the electrolyte composition.

38. A method of forming an electrochemical device comprising:
(i) injecting the electrolyte composition of claim 23 into a spiral wound cell or a prismatic cell; or
(ii) coating a surface of an electrode substrate with the electrolyte composition of any of claims 22-34 and assembling the electrode substrate with a porous separator; or
(iii) providing a precursor solution comprising the electrolyte composition of claim 23; forming a solid or gel composition from the precursor solution to form a film on an anode substrate, a cathode substrate, and/or a separator; and positioning the separator between the anode substrate and the cathode substrate such that the electrolyte contacts the anode and the cathode.
